(19) United States
(12) Patent Application Publication
(10) Pub. No.: US 2017/0051366 A1
(43) Pub. Date: Feb. 23, 2017

(54) PELT BOARD FOR DRYING TUBULAR PELTS

(71) Applicant: Eikon Technologies Holding S.à.r.l., Luxembourg (LU)

(72) Inventor: Kurt Pedersen, Vinderup (DK)

(21) Appl. No.: 15/238,625

(22) Filed: Aug. 16, 2016

(30) Foreign Application Priority Data
Aug. 17, 2015 (DK) PA201570532

(51) Int. Cl. C14B 1/58; C14B 1/26

(52) U.S. Cl. CPC C14B 1/58; C14B 1/26

(57) ABSTRACT

A pelt board for tubular furs such as mink, includes a foot end and a tip end, and also includes half parts extending between opposite longitudinal edges, and an internal cavity for distributing drying air between the half parts. A distension system is configured to reduce or increase the circumference of the pelt board dependent on the setting of said distension system. The half parts include ventilation openings, which provide a flow of drying air between the internal cavity and the outer surface of the half parts. The outer surface of at least one of the half parts includes an outer guiding recess for receiving an air exchange part. The guiding recess extends substantially from the tip end of the pelt board in a direction towards the foot end, and ends substantially at a drying air supply opening to the internal cavity.

### CROSS-REFERENCE TO RELATED APPLICATION

This application claims priority to Danish Patent Application No. PA 201570532 filed on Aug. 17, 2015, the disclosure of which including the specification, the drawings, and the claims is hereby incorporated by reference in its entirety.

### FIELD OF THE INVENTION

The invention relates to a pelt board for drying tubular furs such as mink furs, a drying system for drying tubular pelts, a method of drying tubular furs and use of a pelt board.

### BACKGROUND

Pelt boards for drying tubular pelts such as mink furs, fox furs or the like are well known. Such pelt boards has a foot end and a tip end, and may be configured for receiving drying air at a tip end of the pelt board when a tubular fur is arranged on the pelt board with the skin side facing the pelt board. U.S. Pat. No. 824,364 and U.S. Pat. No. 3,313,038 discloses older drying systems where drying air is provided at a tip end of a pelt board. Newer pelt boards for drying tubular furs such as mink furs, e.g. as disclosed in WO 2005/026394 A1 and WO 2014/032950, may comprises an internal cavity in the pelt board for distributing drying air to ventilation openings provided at the surface of the pelt boards. Drying air is provided through an air supply inlet at a foot end of the pelt board into the cavity, and therefrom through the ventilation openings to the skin side of the fur. Such pelt boards are also capable of reducing or increasing the circumference of the pelt board dependent on the setting of a distension system of the pelt board in order to allow easier release of the tubular pelt from the pelt board after drying.

The presently available pelt board solutions, such as pelt board solutions comprising distensions systems, may however suffer from drawbacks in relation to providing drying air to the pelt board. It may thus e.g. be an object of the present invention to provide an advantageous solution for providing drying air to pelt boards.

### SUMMARY OF THE INVENTION

The invention relates to a pelt board for drying tubular furs such as mink furs, wherein said pelt board comprises a foot end and a tip end, and wherein said pelt board comprises:
half parts extending between opposite longitudinal edges of said pelt board, and an internal cavity for distributing drying air in said pelt board between said half parts, and
a distension system configured to reduce or increase the circumference of said pelt board dependent on the setting of said distension system,
   wherein said half parts comprises a plurality of ventilation openings for providing a flow of drying air between said internal cavity and the outer surface of said half parts, and
   wherein the outer surface of at least one of said half parts comprises an outer guiding recess for receiving an air exchange part for exchanging air in said internal cavity when a tubular fur is arranged on said pelt board, which guiding recess extends substantially from said tip end of the pelt board in a direction towards said foot end, and which guiding recess ends substantially at a drying air supply opening to said internal cavity.

Hollow pelt boards with half parts enclosing an internal cavity for guiding and distributing drying air internally in the pelt board, and a distension system, comprises movable parts in the internal cavity in order to provide the distension function. Such movable parts may e.g. comprise a spear/guiding member extending into the pelt board from the foot end of the pelt board and/or other means that are adapted to e.g. displace substantially flat, longitudinal profiles arranged at the longitudinal edges of the pelt board, or to displace the half parts themselves. This necessarily takes up space inside the cavity.

There is generally little space in the cavity at the tip end of the pelt board, and the tip end of the pelt board may also suffer from being more vulnerable to external forces than the wider/larger foot end of the pelt board.

By the present invention, it is be possible to solve the space issues at the tip end of the pelt board and provide a more durable pelt board having a distension feature and an internal cavity enclosed by half parts, and which is suitable for receiving drying air from the tip end part of the pelt board during a drying process where a tubular pelt is arranged at the pelt board with the skin side facing the pelt board surfaces.

The guiding recess may provide that the air exchange part such as a rigid pipe or the like can be guided between a tubular pelt on the pelt board and the outer surface of the pelt board from the tip end of the pelt board to a suitable location. The air exchange part is thus guided in the recess along the outer surface of the pelt board to a location where space issues are reduced as the width of the pelt board may gradually increases towards the foot end of the pelt board at least at the longitudinal edges. The drying air can then be provided to (or extracted from) the internal cavity at that location through the drying air supply opening.

Moreover, the present solution may provide a more advantageous distribution of the drying air inside the pelt board cavity as the drying air is not supplied at the outmost tip end of the pelt board, but is instead supplied at a distance from the outmost tip end at the drying air supply opening in the outer surface of at least one of said half parts. The guiding recess may thus be configured to guide an air exchange part such as a pipe or the like to a position near the drying air supply opening.

The half parts provide broad outer support surfaces preferably having a plurality of elevations for supporting the skin side of the fur, which broad outer support surfaces extend between the more narrow longitudinal edges.

In aspects of the invention, said drying air supply opening may extend between the recessed surface of said guiding recess and an upper, elevated edge of said half part, which upper elevated edge is elevated compared to said recessed surface.

The drying air supply opening hereby extends in a substantially transverse direction compared to the longitudinal direction of the pelt board. The air can thus flow into the pelt board's internal cavity in the longitudinal direction of the pelt board, which may provide that more air is supplied into the cavity and/or in that the air supply is supplied more consistently towards the foot end. The drying air may hereby experience little resistance when provided into the pelt board cavity and thus, a more efficient drying air may thus be provided. This may e.g. also be advantageous if the same air supply unit such as a motor/fan combination provides drying air to a plurality of pelt boards.

Said drying air supply opening may in aspects of the invention have a height difference between the upper, elevated edge and the recessed surface between the between 1.5 mm and 20 mm such as between 2 mm and 10 mm.

In other aspects of the invention, the drying air supply opening may be provided substantially in the surface of the guiding recess and do not extend transverse to the longitudinal axis.

In preferred aspects of the invention, said drying air supply opening may be arranged away from a first plane extending through said opposite longitudinal edges and preferably also said tip end.

Preferably, said guiding recess comprises a groove or consist of a groove in the outer surface of at least one of said half part, so that the groove extends in the longitudinal direction of the pelt board.

In preferred aspects of the present invention, said guiding recess is configured to provide an opening between the recessed surface of said guiding recess and a tubular fur, when said tubular fur is arranged on the pelt board so that the air exchange part can be inserted between said recessed surface and said tubular fur after the tubular pelt is arranged on the pelt board.

This provides that the air exchange part may advantageously be provided after the tubular fur is arranged on the pelt board, e.g. stretched on the pelt board and fixed to the board by means of a holding bag, a flexible sheet of plastic or the like wrapped around the pelt board or the like. This may provide an efficient process when preparing a plurality of pelts on pelt boards for drying.

In advantageous aspects of the present invention, the length of said guiding recess is no more than ¼ of the length of the pelt board such as no more than 1/10 of the length of the pelt board, e.g. no more than 1/15 of the length of the pelt board, e.g. about 1/20 of the length of the pelt board.

This may e.g. provide that the drying air can be introduced into the interior cavity between the half parts after the space and/or strength issues at the tip end due to e.g. the tapering form of the pelt board are overcome. The drying air may hereby be provided at the half of the pelt board comprising the tip end and from here distributed towards the foot end. This may provide advantages in relation to obtain a satisfactory drying of the tubular fur.

In preferred aspects of the invention, at least one of said half part provides a curved outer profile.

In aspects of the invention, both half parts may comprise a curved outer profile extending between the longitudinal edges, but in other embodiments of the invention, at least one of the half parts may have a substantially flat profile. The guiding recess may be arranged in the surface of a half part having a flat profile and/or in the surface of a half part having a curved profile.

In preferred aspects of the invention, said pelt board may comprise a first plane extending through said longitudinal edges of said pelt board, and a second centre plane extending in the longitudinal direction of the pelt board and being substantially perpendicular to said first plane, which second plane preferably extends through said guiding recess.

In aspects of the invention where the second centre plane extends through the guiding recess the guiding recess will be arranged substantially at the middle of the pelt board from the tip end. This may provide advantages in relation to holding the pelt board while it hangs vertically from a holding arrangement to solve balancing issues and/or in order to provide a more mechanically resistant tip end part of the pelt board.

The guiding recess may in preferred aspects of the invention comprise a support surface for supporting said air exchange part such as a rigid pipe, when said air exchange part is arranged in said guiding recess between a tubular fur arranged on the pelt board, and the support surface of said guiding recess.

The air exchange part such as (preferably) a rigid pipe or a flexible hose may thus be pressed towards the support surface by the pelt and/or by a clamp or the like of a holding arrangement. This provides that the pelt board may hang freely from the tip end of the pelt board during drying.

In advantageous aspects of the invention, said distension system is configured to be operated at the foot end of said pelt board in order to either expand or collapse said pelt board, preferably by displacing a protruding part of a longitudinal member of said distension system in the longitudinal direction of the pelt board, which longitudinal member extends in the longitudinal direction of said pelt board inside said cavity.

This may e.g. provide that existing, and experientially well-functioning distension systems, may be utilized which may also fit into existing drying systems. Such systems provides e.g. that a protruding part of a longitudinal member inside the pelt board is operated at the foot end where there is more space and the pelt board may be, mechanically speaking, stronger. Also, such a protruding part may in aspects of the invention be utilised in other drying systems for providing drying air through the foot end while the pelt board stands vertically from a drying aggregate so the protruding part of the longitudinal member extends into an opening of the drying aggregate.

In advantageous aspects of the invention, said pelt board may moreover be configured for receiving drying air through a further drying air supply opening to said interior cavity at the foot end of said pelt board, e.g. by supplying air into a channel of a longitudinal member of said distension system.

Hereby, the supply of drying air may be provided either through the foot end and/or by means of the first drying air supply opening in the guiding recess at the tip end. One pelt board may thus be constructed to fit different types of drying systems and this may have advantageous environmental impacts and/or production related impacts as well as users may have more freedom of choosing and in that a reduced number of pelt board types may be produced. As the types of pelt boards and drying systems evolve, it might be advantageous for a user to not be bound by purchasing a large amount of pelt boards that needs to fit a specific drying system.

Also, if a pelt from larger skin types such as fox skins and/or special types of mink skin suffers from being more demanding to dry properly; drying air may in aspects of the invention be provided both by means of the guiding recess and through the foot end.

In aspects of the invention, said drying air supply opening at said tip end part may be oblong, such as wedge shaped, rectangular or oval, and extends in the longitudinal direction of said pelt board.

This may provide that more drying air may be provided at guiding recess, and/or that the air resistance may be reduced. As there is little space at the tip end of the pelt board, providing an oblong opening may be advantageous in order to enable a sufficient drying air supply to the internal cavity of the pelt board, while providing a sufficient mechanical strength of the pelt board at the tip end part.

The drying air supply opening may in aspects of the invention extend in a substantially transverse direction compared to the longitudinal direction of said pelt board. This may e.g. provide that the drying air can enter the internal cavity in the longitudinal direction of the pelt board.

The internal cavity of the pelt board extends in advantageous aspects of the invention between a recessed wall part providing said guiding recess and the opposing half part.

This may e.g. help to provide a sufficient drying at the tip end part of the pelt board as the air may be guided past this part of the internal cavity by the air exchange part and enter the internal cavity further towards the foot end through the drying air supply opening. The drying air can then from there move towards the tip end in the internal cavity at the tip end part to dry a part of the skin covering the guiding recess and the tip end part of the half part opposite the guiding recess supporting the air exchange part.

In aspects of the invention, a recessed wall part providing said guiding recess may be displaced from a first plane P1 extending through said longitudinal edges of said pelt board in the longitudinal direction of said pelt board, so that drying air can flow between said first plane and the inner surface of the wall part inside the cavity, and preferably so that a longitudinal member for operating the distension system can extend between said wall part and the other half part substantially in said first plane.

This may e.g. help to provide a sufficient drying at the tip end part of the pelt board, and even also provide that the distension system may provide sufficient change of the circumference at the pelt board at the tip end part in order to assure that the pelt can easily be removed from the pelt board after drying.

The invention moreover in a second aspect relates to a drying system for drying tubular pelts, where said drying system comprises one or more pelt boards according to any of the preceding claims, and one or more holding devices, each holding device comprising a holding arrangement such as a clamp for holding said pelt board so that the pelt board hangs substantially vertically from said holding device from the tip end of said pelt board, and wherein said holding device preferably moreover comprises said air exchange part such as a rigid pipe or a hose to be provided in said guiding recess from said tip end between said tubular fur and the surface of said guiding recess.

The pelt board preferably hangs vertically during drying without being supported at the foot end of the pelt board.

The invention moreover in a third aspect relates to a method of drying tubular furs such as mink furs on a pelt board, wherein said pelt board comprises:
a foot end and a tip end,
half parts extending between opposite longitudinal edges of said pelt board, an internal cavity for distributing drying air in said pelt board between said half parts, and
a distension system configured to reduce or increase the circumference of said pelt board dependent on the setting of said distension system,
wherein said half parts comprises a plurality of ventilation openings for providing a flow of drying air between said internal cavity and the outer surface of said half parts, and
wherein the outer surface of at least one of said half parts comprises an outer guiding recess for receiving an air exchange part for exchanging air in said internal cavity when a tubular fur is arranged on said pelt board, which guiding recess extends substantially from said tip end of the pelt board in a direction towards said foot end, and which guiding recess ends substantially at a drying air supply opening to said internal cavity,
   wherein said method comprises the steps of:
   drawing said tubular fur onto said pelt board from said tip end towards said foot end so the skin side of the tubular pelt faces the outer surface of said pelt board,
   fixing the pelt to the pelt board by fixation means,
   providing an air exchange part into said guiding recess between the surface of said guiding recess and said tubular pelt from the tip end of said pelt board, e.g. through a mouth opening of said tubular fur, and
   providing a flow of drying air by means of said air exchange part so as to provide an airflow in said internal cavity of said pelt board through said drying air supply opening so that air between said tubular fur and the outer surface of said half parts is exchanged.

The fixation means may in aspects of the invention comprise a holding bag or a plastic sheet wrapped around the pelt/fur at the pelt board at a holding area near the foot end of the pelt board.

In an embodiment of said a third aspect said method may comprises the step of arranging said pelt board at a holding device by means of a holding arrangement such as a clamp so that said pelt board hangs substantially vertically from said holding device from the tip end part of said pelt board.

In embodiments of said third aspect, said holding device comprises said holding arrangement and said air exchange part.

In embodiments of said third aspect, said pelt board is a pelt board according to any of claims 1-13.

The invention moreover in a fourth aspect relates to use of a pelt board according to any of claims 1-13, where a flow of drying air in the interior cavity of said pelt board is provided by means of an air exchange part, which air exchange part is inserted in a guiding recess extending towards the foot end of said pelt board from the tip end of said pelt board so that the air exchange part is placed between said tubular fur and an outer surface of said guiding recess.

The invention may moreover in a fifth aspect relate to a pelt board for drying tubular furs such as mink furs, wherein said pelt board comprises a foot end and a tip end, and wherein said pelt board comprises:
half parts extending between opposite longitudinal edges of said pelt board, and an internal cavity for distributing drying air in said pelt board between said half parts, and wherein said half parts comprises a plurality of ventilation openings for providing a flow of drying air between said internal cavity and the outer surface of said half parts,
   wherein the outer surface of at least one of said half parts comprises an outer guiding recess for receiving an air exchange part for exchanging air in said internal cavity when a tubular fur is arranged on said pelt board, which guiding recess extends substantially from said tip end of the pelt board in a direction towards said foot end, and which guiding recess ends substantially at a drying air supply opening to said internal cavity, and
   wherein said pelt board is moreover configured for receiving drying air through a further drying air supply opening to said interior cavity at the foot end of said pelt board.

This may e.g. provide an advantageous solution in relation to providing a reliable and efficient pelt board solution that can be utilized in different drying systems.

It is generally to be understood that the pelt board according to said fifth aspect may be combined with any other suitable aspect/embodiment of the invention as described e.g. in relation to any of the first, second third and/or fourth aspect above. Moreover, it is to be understood that the pelt board in further aspects of the invention may be a pelt board according to any of claims 1-13.

### BRIEF DESCRIPTION OF THE DRAWINGS

Aspects of the present disclosure will be described in the following with reference to the figures in which:

FIGS. 1 and 2: illustrates a pelt board for drying tubular furs such as mink furs, according to embodiments of the invention,

FIG. 3: illustrates a cross sectional view of the pelt board according to embodiments of the invention,

FIG. 4: illustrates an embodiment of a distension system of a pelt board according to embodiments of the invention,

FIG. 5: illustrates an embodiment of pelt board according to embodiments of the invention,

FIGS. 6a-6b: illustrate a pelt board having a distension system according to further embodiments of the invention

FIGS. 7-8: illustrate a cross sectional view of a tip end part of a pelt board according to embodiments of the invention,

FIG. 9: illustrates a pelt board according to embodiments of the invention seen from the tip end of the pelt board,

FIG. 10: illustrates a further embodiment of a pelt board seen from the foot end according to embodiments of the invention,

FIGS. 11a-11b: illustrate a drying system according to embodiments of the invention,

FIG. 12: illustrates a further embodiment of the pelt board according to embodiments of the invention,

FIG. 13: illustrates an embodiment of the invention wherein an oblong drying air supply opening has an oval shape,

FIG. 14: illustrates a further embodiment of a drying system according to embodiments of the invention, and

FIGS. 15a-15b: illustrates a cross-section of a pelt board at a holding area according to embodiments of the invention.

### DETAILED DESCRIPTION OF THE PREFERRED EMBODIMENTS

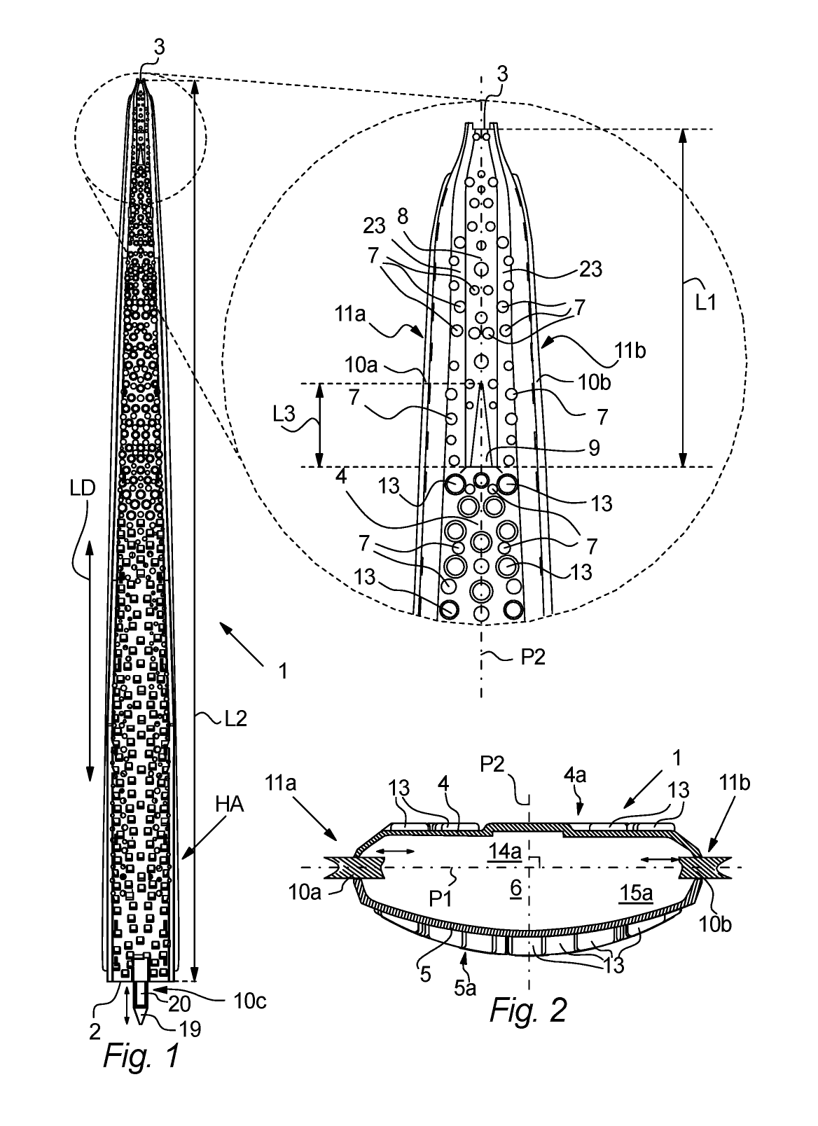

FIG. 1 illustrates a pelt board 1 for drying tubular furs such as mink furs, according to embodiments of the invention. The pelt board has a foot end 2 and a tip end 3. The foot end 2 is wider and has a larger circumference than the tip end 3.

The pelt board 1 comprises two half parts 4, 5 (half part 4 is illustrated in FIG. 1, see also FIG. 2 illustrating a cross sectional view of the pelt board 1 seen from the foot end 2). The half parts 4, 5 each comprise a plurality of elevations/protrusions 13 at the exterior surfaces, and the half parts 4, 5 extend between opposite longitudinal side edges 11a, 11b of the pelt board 1. The elevations 13 may in embodiments of the invention comprise circular elevations (illustrated in FIG. 1 by two rings, one inside the other) and/or rectangular elevations or any combination thereof. The circular elevations 13 may in embodiments of the invention have a substantially frustoconical shape.

The tubular fur 30 to be dried on the pelt board may in preferred embodiments of the invention be a mink fur or a fox fur.

The half parts 4, 5 provides an internal cavity 6 for distributing drying air internally in the pelt board 1 between the half parts 4, 5, see FIG. 2. It is noted that internal parts of the pelt board 1 in the cavity 6, in the form of elements of the distension system of the pelt board, connection parts for interconnecting the half parts 4, 5 and/or the like has been omitted in FIG. 2 in order to enhance the understanding and simplicity of the drawing.

In preferred embodiments of the invention, both half parts 4, 5 as illustrated in FIG. 2 each comprises a hollow 14a, 15a which together provides the internal cavity 6 between the half parts 4, 5.

The half parts 4, 5 may in embodiments of the invention each extend substantially from the foot end 2 to the tapered end 3, and may each be in one piece. In other embodiments of the invention (not illustrated), the half parts may be divided into two, three or more subparts which together provided the half parts providing the support surfaces with elevations 13 and ventilation openings 7 when the pelt board 1 is assembled.

A plurality of ventilation openings 7 for providing a flow of drying air between the internal cavity 6 and the outer surface of the half parts 4, 5 are provided in the half parts 4, 5, see FIG. 1. These ventilation openings 7 are arranged in the surface of the respective half part 4, 5 between the elevations 13. Hereby drying air can be provided from the internal cavity 6 to the exterior of the pelt board between a tubular fur arranged on the pelt board 1 with the skin side facing the pelt board, and the pelt board surface 4a, 5a so as to dry the tubular fur. Hence, when a tubular fur is arranged at the pelt board 1, the skin side will support on the elevations 13, and thus a cavity is formed between the outer surface 4a, 5a of the half part and the skin side of the tubular fur. Air can thus be provided into this cavity between the outer surface 4a, 5a of the respective half part 4, 5 and the skin side of the tubular fur from the internal cavity 6 of the pelt board, through the ventilation openings 7 and hereby dry the skin.

The pelt board 1 moreover comprises a distension system configured to reduce or increase the circumference of the pelt board dependent on the setting of the distension system. In the present example, the distension system comprises two longitudinal parts 10a, 10b extending along the longitudinal edges 11a, 11b of the pelt board.

As illustrated in FIG. 2, the longitudinal edges 11a, 11 b define a first plane P1 extending through the longitudinal edges 11a, 11b of the pelt board 1. A second centre plane P2 is substantially perpendicular to the first plane P1, and both planes P1, P2 extends in the longitudinal direction LD of the pelt board 1.

The longitudinal parts 10a, 10b can be operated in order to increase the overall circumference of the pelt board, in the present example by moving the longitudinal parts towards or and away from the second plane P2. When the longitudinal parts 10a, 10b have been arranged in an “expanded” position (As illustrated in FIG. 2), they are moved away from the second plane P1. When the longitudinal parts 10a, 10b have been arranged in a “collapsed” position they are moved towards the second plane P2. In the collapsed position, the overall circumference of the pelt board 1 is smaller than when the longitudinal parts 10a, 10b are arranged in the expanded position. The half parts 4, 5 are preferably thus kept in a fixed position and the expansion and collapsing of the pelt board may alone be provided by controlling the longitudinal parts 10a, 10b at the longitudinal edges 11a, 11b of the pelt board 1.

The moving of the longitudinal parts 10a, 10b at the longitudinal edges 11a, 11b of the pelt board 1 is preferably provided by moving the longitudinal parts 10a, 10b in the first plane P1.

The half parts 4, 5 are in preferred embodiments of the invention substantially symmetric around at least the centre plane P2, but in other embodiments of the invention, the half parts 4, 5 may not be symmetric around the centre plane P2.

The half parts 4,5 may in embodiments be connected by mechanical fastening means such as screws, a latch/notch fastening system where latches and notches are configured to interconnect and/or by means of e.g. an adhesive.

The half parts 4, 5 may thus in preferred embodiments of the invention be kept in a fixed position and are not movable relative to each other as the longitudinal parts 10a, 10b provides the collapsible function. However, in other embodiments of the invention (not illustrated), the half part of the pelt board 1 may be half shells defining arched surfaces, and the distension system of the pelt board may be arranged to move these half shells towards and away from each other, e.g. as disclosed in WO 2005/026394 A1.

In embodiments of the invention, at least one of the half parts 4 may have a substantially flat profile, in this case half part with ref 4. The other half part (in this half part 5) may have a substantially curved profile and preferably provide a half shell. In other embodiments of the invention, both half parts may have a substantially curved outer profile and form half shells having arched outer profiles.

As illustrated in FIG. 1, one of the half parts 4, 5 comprises an outer guiding recess 8 for receiving an air exchange part that can exchange air in the internal cavity 6.

The guiding recess 8 extends substantially from the tapered end/tip end 3 of the pelt board 1 in a direction towards the foot end 2. The guiding recess 8 ends substantially at a drying air supply opening 9 to the internal cavity 6. The guiding recess 8 is arranged so that a pipe or the like can extend in between a pelt on the pelt board 1 (described in more details later on) from the tip end 3, and thus provide drying air into, or extract drying air from, the internal cavity 6 through the drying air supply opening 9.

In preferred embodiments of the invention, the drying air supply opening 9 extends in a substantially transverse direction compared to the longitudinal axis of the pelt board.

In advantageous embodiments of the invention, the length L1 of the guiding recess 8 is no more than ¼ of the length L2 of the pelt board 1 such as no more than 1/10 of the length of the pelt board, e.g. no more than 1/15 of the length of the pelt board, e.g. about 1/20 of the length of the pelt board.

In advantageous embodiments of the present invention, the drying air supply opening 9 at the tip end 3 part is oblong and extends in the longitudinal direction LD of said pelt board 1. In the present example, the longitudinal has a wedge shape, and the wedge shaped drying air supply opening tapers towards the tip end 3 of the pelt board. However, it may also be rectangular, oval-shaped or the like in other embodiments.

The length L3 of the drying air supply opening 9 may be between 1.5 cm and 20 cm such as between 2 cm and 10 cm, e.g. between 2.5 and 6 cm. The width off the opening may be between 0.5 and 5 cm such as between 0.5 and 3 cm, e.g. about 1 cm or 2 cm.

The pelt board tapers towards the tip end 3 so the foot end 2 is wider than the tip end 3 (measured between the edges 11a, 11b).

The half parts 4, 5 provide broad outer surfaces 4a, 5a which extend between the more narrow longitudinal edges 11a, 11b.

The pelt board 1 comprises a holding area HA at the foot end 2 part of the pelt board 1. The holding area HA is not necessarily of a well-defined longitudinal extend and the properties defined for the holding area, such as the cross-sectional outer contours of the two broad side surfaces being linear and convex, respectively, may also apply beyond the extend of the holding area, such as throughout the whole of the pelt board's longitudinal extend. The holding area may e.g. extend between 25-50 cm from the foot end 2 and comprise elevations for providing a holding force when e.g. a holding bag or a flexible material is provided at the outer surface of the skin around the holding area. The pelt board edges 11a, 11b tapers toward the tip end 3 from the holding area HA and/or the foot end of the pelt board.

According to an embodiment of the present invention, the pelt board may be designed to be used for mink pelts of male minks according to a US standard, for which reason the cross-sectional circumference of the pelt board at the holding area HA is in the range of 220 to 240 millimetres. According to another embodiment of the present invention, the pelt board is designed for mink pelts of male mink according to a European standard, for which reason the cross-sectional circumference of the pelt board 1 at the holding area is in the range of 242 to 260 millimetres. For pelt boards according to these embodiments, the length L1 of the pelt board from the tip end 3 to the foot end 2 thereof is preferably in the range of 120 to 160 centimetres, more preferably in the range of 125 to 155 centimetres.

According to a further embodiment of the present invention, the pelt board may be designed for use for mink pelts of female mink, for which reason the cross-sectional circumference of the pelt board at the holding area HA is in the range of 180 to 200 millimetres. For pelt boards according to this embodiment, the length of the pelt board from the tip end to the foot end thereof is preferably in the range of 100 to 130 centimetres, more preferably in the range of 105 to 120 centimetres.

According to a still further embodiment of the present invention, the pelt board 1 may be designed for use for fox pelts, for which reason the cross-sectional circumference of the pelt board at the holding area HA is in the range of 380 to 400 millimetres. For pelt boards according to this fourth embodiment, the length of the pelt board from the tip end to the foot end thereof may preferably be in the range of 170 to 200 centimetres.

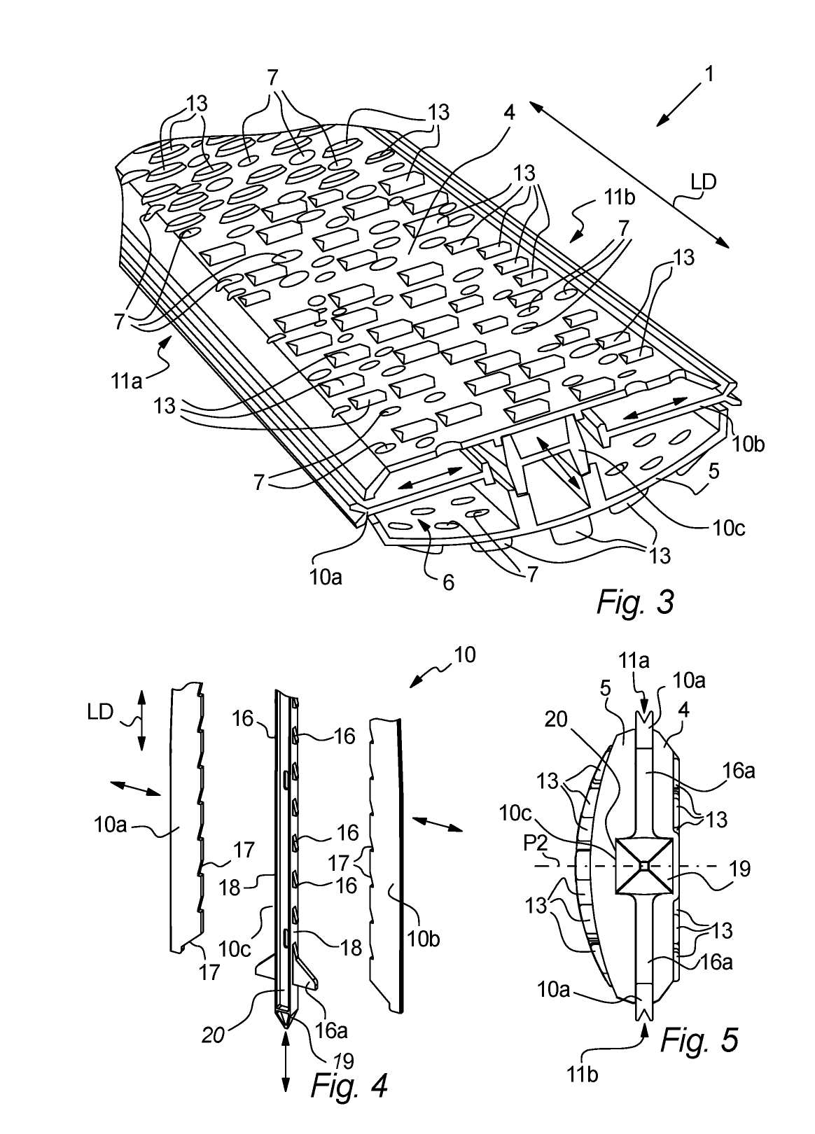

FIG. 3 illustrates a cross sectional view of the pelt board 1 seen in perspective according to embodiments of the invention, where an embodiment of the distension system is illustrated in more details.

The distension system comprises the longitudinal parts 10a, 10b which are configured to be operated in order to increase or decrease the overall circumference of the pelt board 1. Moreover, the distension system comprises a longitudinal member 10c in the internal cavity 6 between the half parts 4, 5, extending in the longitudinal direction LD of the pelt board 1. The longitudinal member 10c is arranged between the longitudinal parts 10a, 10b, and when the longitudinal member 10c is displaced in the longitudinal direction LD of the pelt board 1, the longitudinal parts 10a, 10b are is displaced relative to the half parts 4, 5 in a direction away or towards the second plane P2, see FIG. 2.

This may be provided by the longitudinal member 10c comprising a plurality of wedge-shaped elements 16 configured to fit into recesses 17 in the longitudinal parts 10a, 10b as described in more details in connection to FIG. 4.

As can be seen from FIG. 3, the pelt board 1 comprises a plurality of elevations 13 at the outer surface of the half parts 4, 5, and a plurality of ventilation openings 7 provided between the elevations in order to enable a flow of drying air between the exterior of the pelt board and the internal cavity 6.

FIG. 4 illustrates an embodiment of a distension system 10 according to embodiments of the invention, seen in perspective. The longitudinal member 10c comprises a plurality of wedge-shaped elements 16, arranged at and along opposing surfaces 18 of the longitudinal member. The wedge-shaped elements 16, 16a are configured to fit into recesses 17 in the longitudinal parts 10a, 10b when the distension system 10a, 10b, 10c is arranged in a collapsed state. When displacing the longitudinal member 10c in a direction towards the tip end 3 of the pelt board, relative to the half parts 4, 5, the wedge shaped elements 16, 16a forces the longitudinal parts 10a, 10b away from the longitudinal member 10c to an expanded position, thereby increasing the circumference of the pelt board 1 as the longitudinal parts 10a, 10b extends further out between the half parts 4a, 5a at the longitudinal edges 10a, 10b than when in a collapsed position.

The longitudinal member 10c comprises a lower part 19 extending in the longitudinal direction LD of the pelt board from the foot end 2 of the pelt board. This part provides a part of the distension system 10 that can be operated in order to provide the displacement of the longitudinal member 10c.

The longitudinal member 10c may in embodiments of the invention comprises a lowest wedge shaped element 16a near the lower part 19. This element 16a is configured to block the foot end of the pelt board so that air is substantially only supplied at the channel 20 and thus e.g. guided more efficiently inside the pelt board in the cavity 6.

Moreover, the longitudinal member 10c may on embodiments of the invention comprise a channel 20 for guiding drying air from a drying aggregate at the foot end 2 to the internal cavity 6 in the pelt board 1. The drying aggregate (not illustrated) may comprise a top plate with openings for receiving the lower part 19 and be configured to provide drying air to the cavity 6 at the foot end 2 of the pelt board 1 through the channel 20 when the pelt board 1 is arranged vertically in the drying aggregate 1. The drying aggregate may be designed to support a plurality of self-standing pelt boards 1 arranged in the top plate and supply drying air thereto. The drying aggregate may comprise a blowing unit for providing an air flow through the said top plate.

FIG. 5 illustrates an embodiment of the pelt board 1 seen from the foot end 2. The pelt board 1 is in FIG. 5 illustrated in an expanded position, and the longitudinal parts 10a, 10b are displaced away from the centre plane P2 to an outer position to increase the circumference of the pelt board 1.

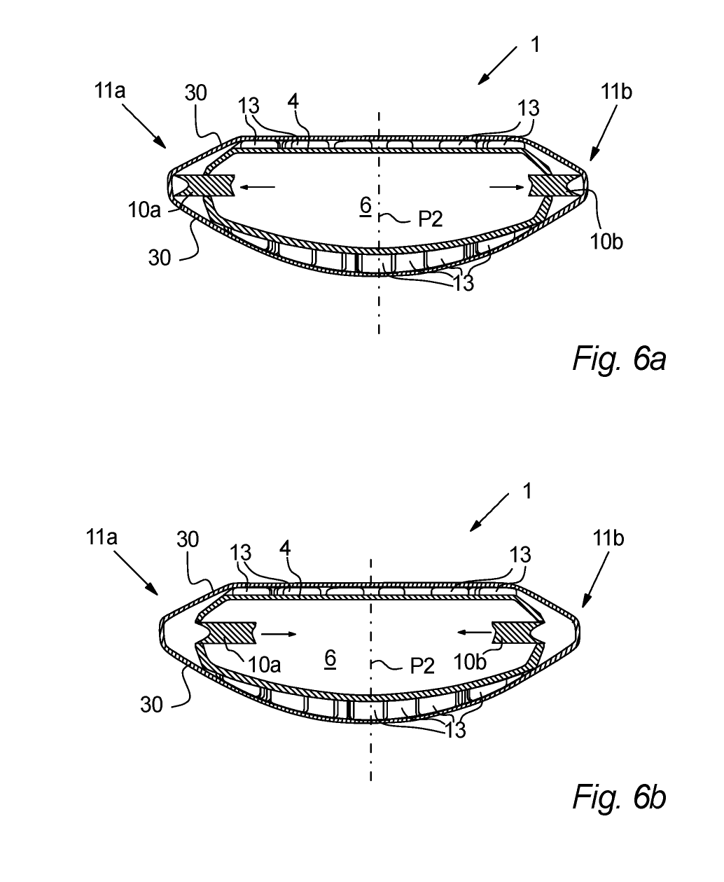

FIG. 6a illustrates a cross sectional view of the pelt board 1 according to embodiments of the invention, where a tubular fur 30 is arranged on the pelt board 1 and the pelt board 1 is in an expanded mode in that the longitudinal parts 10a, 10b are moved away from the plane P2. The tubular fur 30 thus extends around the pelt board while supporting on the elevations/protrusions 13 and the longitudinal parts 10a, 10b. Drying air can thus be guided from the internal cavity 6 and in between the tubular fur 30 and the outer surface of the pelt board 1 between the elevations 13 by means of ventilation openings 7 (not illustrated in FIG. 6, see e.g. FIGS. 1 and 3), thereby drying the skin side of the fur 30.

FIG. 6b illustrates the pelt board of FIG. 6a in a collapsed position as the longitudinal parts are moved towards the interior cavity 6 of the pelt board towards the centre plane P2. Hereby the circumference of the pelt board is decreased. This provides that the tubular fur 30 can now easily be removed from the pelt board 1, even if the fur 30 was fixed to the pelt board in an expanded mode by a holding bag (e.g. as described in WO 2005/026394 A1), a plastic material wrapped around a holding area at the lower part of the pelt board or the like.

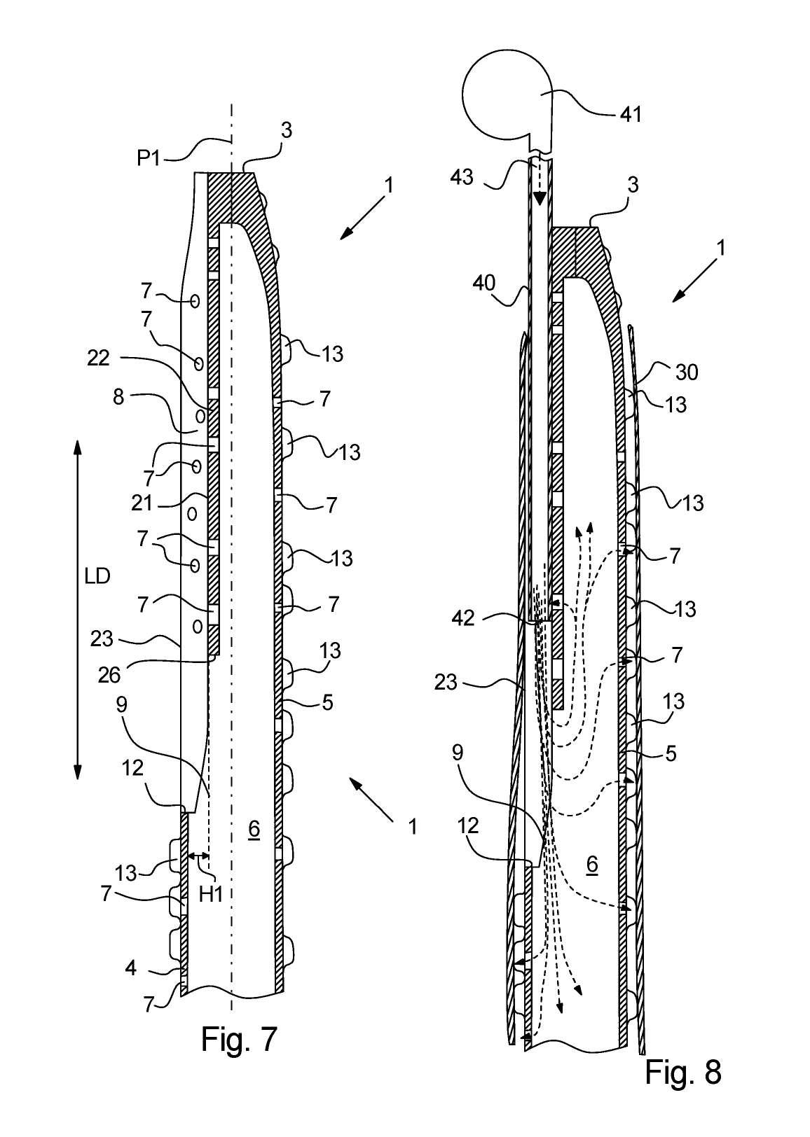

FIGS. 7 and 8 illustrate schematically a cross sectional view of the tip end 3 part of the pelt board 1 at the centre plane P2 (see e.g. FIG. 2) of the pelt board 1, according to embodiments of the invention. It is noted that the number and location of elevations 7 and ventilation openings 13, and/or the exact shape of the tapered end/tip end 3 may be altered in different ways.

The guiding recess 8 extends from the tapered end/tip end 3 of the pelt board 1 and towards the foot 2 end of the pelt board 1 and is formed in a half part 4. The guiding recess 8 may in embodiments of the invention comprise one or more ventilation openings 7 in the guiding recess surface 21 for supporting an air exchange part 40.

The internal cavity 6 extends in between the wall 22 providing the guiding recess surface 21 in the half part 4 and the other half part 5. The wall 22 may e.g. be displaced from the first plane P1 as illustrated so that air can be provided between the plane P1 and the lower surface of the wall 22 facing the cavity 6 and/or so that a longitudinal member 10c (see e.g. FIGS. 4 and 5) can extend between the wall 22 and the other half part 5 to displace the half parts 4, 5 away and towards each other (not illustrated) and/or so that longitudinal parts 10a, 10b can be displaced by the longitudinal member away from a centre plane (P2—see e.g. FIG. 2).

The guiding recess 8 is configured to receive an air exchange part 40 for exchanging air in the internal cavity 6 of the pelt board 1 as illustrated in FIG. 8. The tubular pelt 30 is thus arranged on the pelt board 1 by drawing it onto the pelt board 1 from the tip end 3 towards the foot end 2. The air exchange part 40, preferably in the form of a hollow, rigid pipe, is then entered into the recess 8 from the tip end 30 in a free space formed/provided by the recessed surface 21 of the guiding recess 8 and the tubular fur 30 at the tip end 3 of the pelt board 1. The tubular fur 30 supports on upper surfaces 23 of the half part 4 extending at each side of the guiding recess 6. Such upper surfaces 23 may in embodiments of the invention also comprise elevations 13 and/or ventilation openings 7.

The air exchange part comprises an inlet 43 and an outlet 42 for the drying air.

The air exchange part 40 may in embodiments of the invention be a rigid pipe such as a metal pipe or a rigid plastic pipe, but in other embodiments of the invention, the air exchange part may be a flexible hose such as a plastic hose.

The air exchange part 40 thus extends in the longitudinal direction LD of the pelt board 1 and is thus able to blow drying air into the internal cavity 6 through the Drying air supply opening 9.

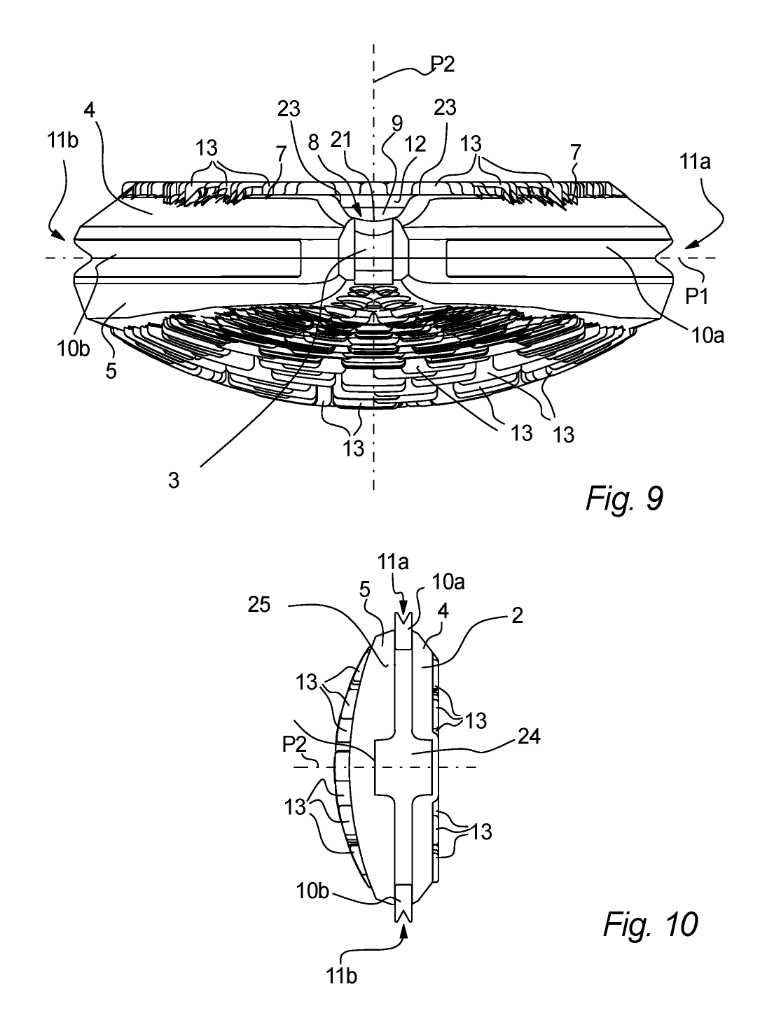

The drying air supply opening 9 extends in embodiments of the invention between the recessed surface 21 of the guiding recess 8 and an upper, elevated edge 12 of the half part 4 comprising the guiding recess 8, see also FIG. 9. The upper elevated edge 12 is thus elevated compared to the recessed surface 21 so that the drying air can enter the cavity 6 between the surface 21 and the upper edge 12 in the longitudinal direction LD of the pelt board. The drying air supply opening 9 thus in preferred embodiments of the invention at least partly extends in a substantially transverse direction compared to the longitudinal direction LD of the pelt board 1, away from a first plane P1 extending through the longitudinal edges 11a, 11b of the pelt board 1, see e.g. FIG. 2.

The drying air supply opening 9 may in embodiments of the invention have a height difference H1 between the upper, elevated edge 12 and the recessed surface 21 between 1.5 mm and 20 mm such as between 2 mm and 10 mm. The height difference H1 may be measured from the lower edge 26 of the opening which may be nearest the tip end 3 if the opening 9 is oblong and extends in the longitudinal direction LD of the pelt board.

The guiding recess 8 ends substantially at the drying air supply opening 9 to the internal cavity 6.

A blowing (or suction) unit 41 can thus be connected to the air exchange part 40 and thus provide a flow of drying air from the exterior of the pelt board 1, through the air exchange part into the cavity 6 where the air is distributed to the ventilation openings 7, or alternatively sucked into the cavity 6 from the ventilation openings.

It is generally to be noted that the pelt board 1 in embodiments of the invention may be configured to receive drying air in the cavity 6 by means of either a drying aggregate for providing drying air at the foot end 2 (e.g. as described previously), or by means of the drying air supply opening at the tip end 3 part of the pelt board 1. A user may thus select where to provide the drying air dependent on the suitable drying system available. In other embodiments of the invention, the pelt board may only be configured for receiving the drying air at the tip end by means of the guiding recess and the drying air supply opening 9.

In preferred embodiments of the invention, the drying air is blown into the cavity 6 by means of a blowing unit 41, e.g. comprising an electrical motor and a fan for being driven by the electrical motor to provide a flow of air into the cavity 6 through the drying air supply opening.

As can be seen in FIGS. 7-8 the internal cavity 6 may extend in between the recessed wall part providing the guiding recess and the opposing half part. The drying air can then after entering the internal cavity 6 at the drying air supply opening 9 move towards the tip end 3 in the internal cavity 6 to dry a part of the skin covering the guiding recess 8 and the tip end part of the half part opposite the guiding recess 6 receiving the air exchange part 40.

FIG. 9 illustrates a pelt board 1 according to the invention seen in perspective from the tip end 3 of the pelt board 1. The pelt board 1 comprises a substantially flat half part 4 (the upper half part) and an opposite half part 5 (the lower half part) providing a substantially arched outer surface. The longitudinal distension parts 10a, 10b of the distension system are configured to move towards and away from the middle/centre plane P2 of the pelt board between the half parts 4, 5 (which half parts in embodiments of the invention may be fixed in relation to each other) in order to provide a collapsible pelt board 1 as e.g. previously explained.

The longitudinal distension parts 10a, 10b may in embodiments of the invention extend in the longitudinal direction LD of the pelt board 1, substantially the entire length of the pelt board such as at least 70% of the length of the pelt board, e.g. at least 80%, such as at least 90% of the length L2 (see FIG. 1) of the pelt board 1.

The pelt board 1 taper towards the tip end 3 by the edges 11a, 11b tapering towards the centre plane P2. Also, it is preferred that at least one, or both of the broad surfaces comprising the elevations 13 may taper towards the tapered towards the first plane 1 defined by the edges 11a, 11b.

FIG. 10 illustrates an embodiment of the pelt board 1 seen from the foot end 2, but where the longitudinal member 10c has been removed in order to illustrate that the pelt board may comprise a further dying air supply opening 24 to the interior cavity 6. The further dying air supply opening 24 is provided in the lower end surface 25 of the pelt board 1 at the foot end 2.

The end surfaces 25 preferably extends perpendicular to the longitudinal direction LD to be able to at least partly stand on a horizontally arranged top plate of a drying aggregate as previously explained.

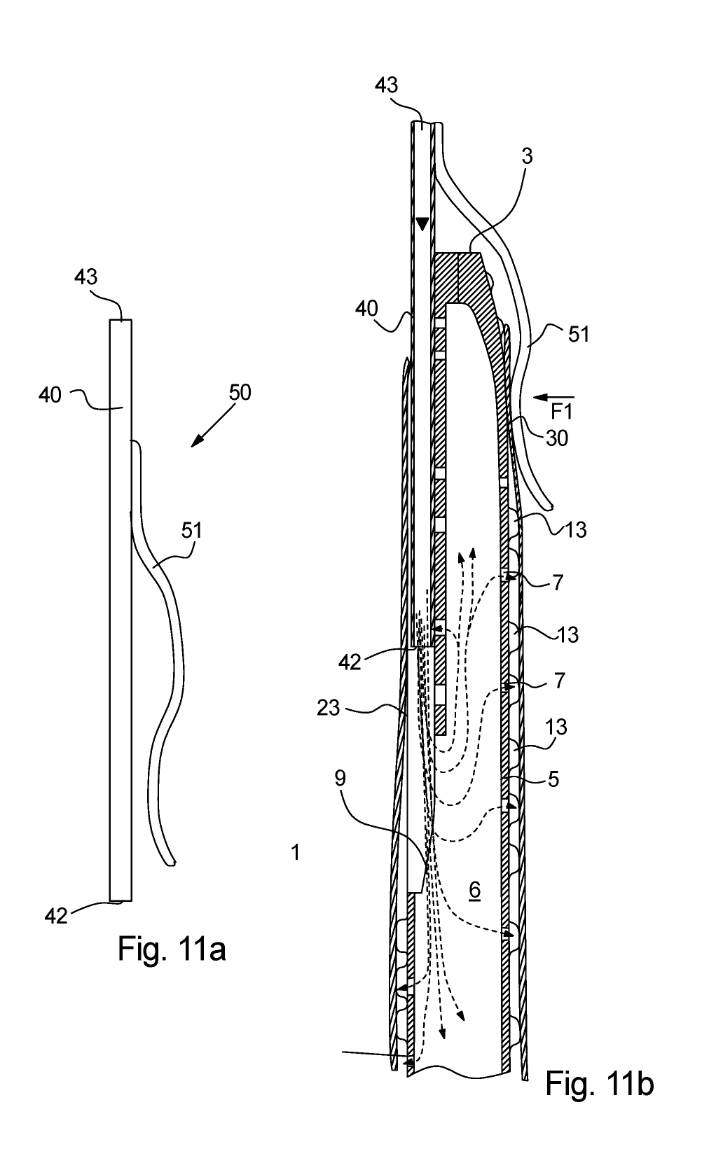

FIGS. 11a-11b illustrate a drying system according to embodiments of the invention. The drying system includes a pelt board 1 according to embodiments of the invention, and a holding device 50. The holding device 50 comprises the air exchange part 40 as previously explained, in the form of an air supply pipe for extending into the guiding recess 8 of the pelt board 1. Moreover, the holding device 50 comprises a holding arrangement 51, preferably in the form of a resilient clamp, a clamp with mechanical locking means, e.g. a latch/not configuration (not illustrated) and/or the like. The holding arrangement 51 is configured to provide a holding function when the air exchange part 40 extends into the guiding recess 8.

Preferably, the holding arrangement 51 includes a resilient clamp 51 for providing a holding force F1 towards the air exchange part 40 when displaced away from the air exchange part 40.

The clamp 51 may thus be arranged at the outside of the pelt 30 when the air exchange part 40 extends into the guiding recess 8, and thereby provide a holding force F1 so that the pelt board 1 can hangs freely and vertically from the holding device 50, by hanging from the tip end 3.

Preferably the pelt board 3 is arranged between the holding arrangement 51 and the air exchange part 40 so that the holding arrangement 51 provides the force F1 towards a half part 5 not comprising the guiding recess 8 into which the air exchange part extends.

It is generally to be understood that the outlet 42 of the air exchange part 40 may not, as illustrated, necessarily extend into the interior cavity 6 of the pelt board 1 but may instead be arranged outside the cavity during drying.

In other embodiments of the invention, the outlet 42 may extend into the interior cavity 6 during drying.

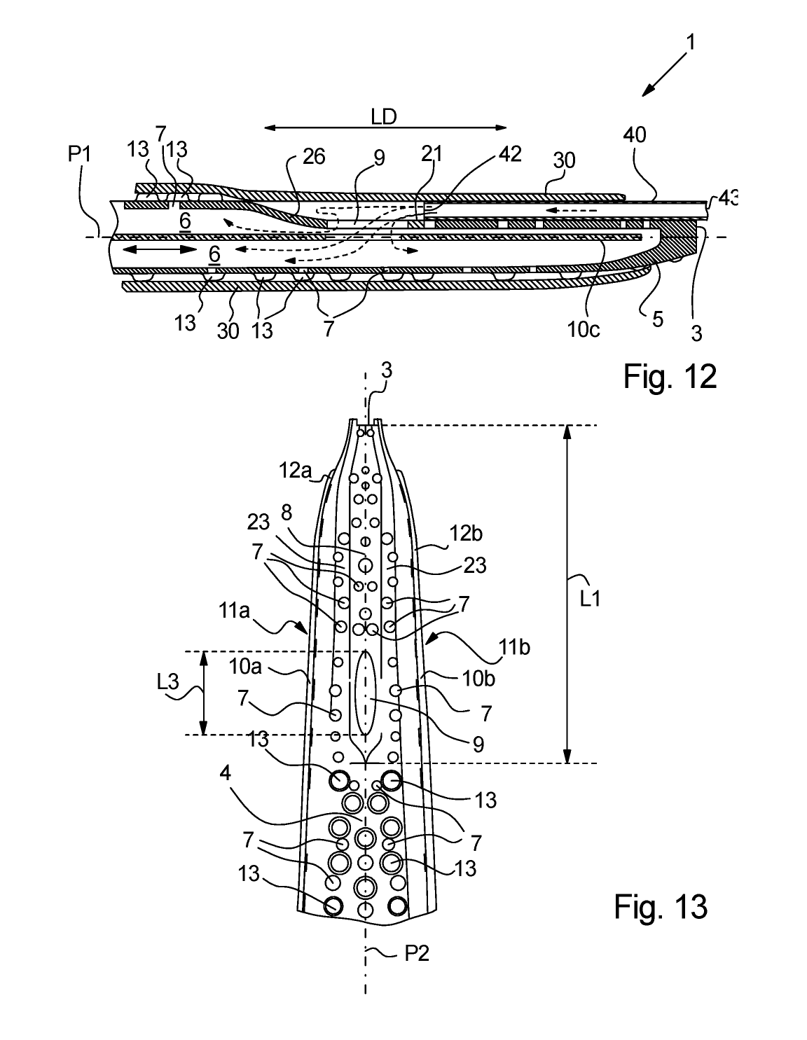

FIG. 12 illustrates an embodiment of the pelt board 1 according to embodiments of the invention, in a cross sectional view of the tip end 3. The drying air supply opening 9 at the tip end 3 part is in this embodiment provided in a plane surface 21 of the half part 4. The opening 9 is preferably oblong and extends in the longitudinal direction LD and do substantially not extend in a transverse direction compared to the longitudinal direction LD of the pelt board 1.

The guiding recess 8 comprises an end wall at the 26 at the distant end of the guiding recess 8 which is distant to the tip end 3. The guiding recess 8 may thus be substantially closed at the end of the guiding recess 8 distant to the tip end 3. The drying air is thus forced from the air exchange part 40 in a direction towards the first plane P1 extending through the side edges 11a, 11b (see FIGS. 1 and 2) and into the cavity 6.

Generally, when the tubular pelt 30 is arranged on the pelt board 1, the pelt/fur 30 and optionally also a fat absorbing bag/tube of a paper material or the like (not illustrated) between skin side of the pelt facing the pelt board 1 and the pelt board surface may substantially prevent drying air from flowing from the guiding recess 8 and in between the elevations 13 providing in cavities between the tubular fur 30 and the outer surface of the half parts 4, 5 from the guiding recess 8. The drying air is thus forced into the opening 9. In other embodiments of the invention, the pelt board may however be designed so that a part of the drying air from the air exchange part 40 will enter into cavities forced between the elevations/protrusions 13 and the skin/fur 30, while the main part of the drying air is introduced/forced into the interior cavity 6.

A fat absorbing bag/tube may generally in embodiments of the invention be utilized between the fur 30 and the pelt board surfaces 4a. 5a.

FIG. 12 moreover illustrates schematically an embodiment of the invention wherein the longitudinal member 10c of distension system arranged in the internal cavity 6 of pelt board 1 extends inside the cavity 6 between the wall 22 providing the guiding recess surface 21 and the half part 5 opposite the half part 4 comprising the guiding recess 6. The longitudinal member 10c may in embodiments of the invention comprise openings arranged substantially opposite to the opening 9 when the pelt board 1 is in an expanded mode so that drying air from the opening 9 can enter through the longitudinal member 10c.

FIG. 13 illustrates an embodiment of the invention wherein the drying air supply opening 9 has an oval shape and extends in the longitudinal direction of the pelt board, in other embodiments of the invention, the drying air supply opening 9 may be oblong and rectangular, wedge shaped, shaped as a trapezoid and/or the like in order to assure that the main part of the air from the air outlet of the air exchange part 40.

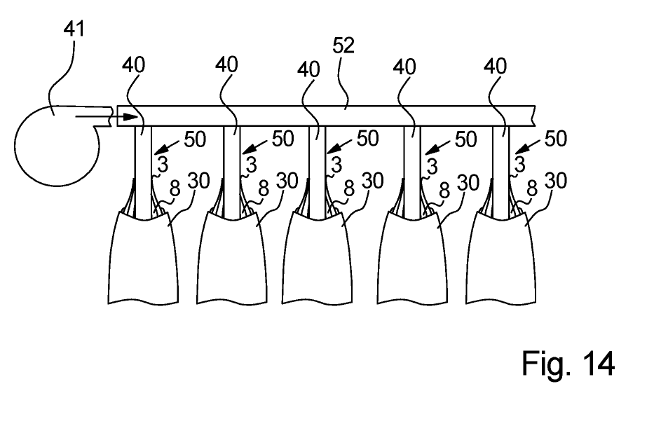

FIG. 14 illustrates an embodiment of the invention in the form of a drying system comprising a plurality of holding devices 50 where a pelt board is hold at the tip end and extends substantially vertically from the holding device. The Air exchange parts 40 are connected to a common air supply 52 connected to a common air supply unit 41 air supply unit for generating flow of drying air in the cavities 6 of the pelt boards 6 to dry the pelts 30 on the pelt boards.

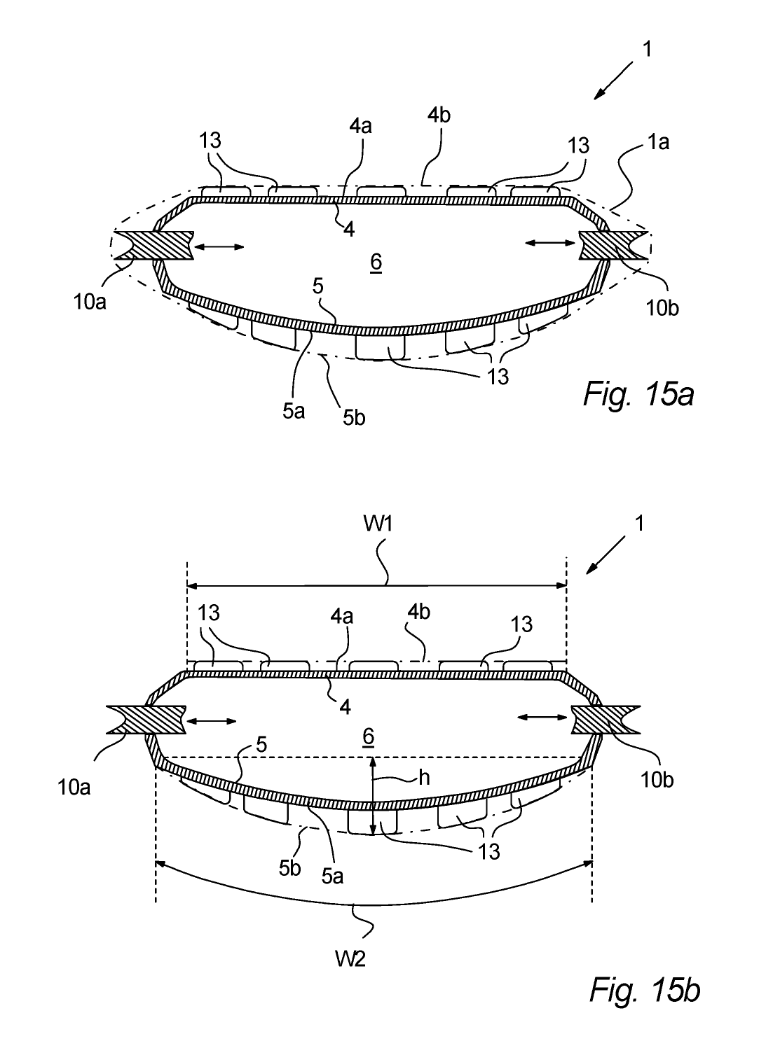

FIG. 15a shows a cross-section of the pelt board 1 at the holding area HA (see FIG. 1), where for clarity only the protrusions 13 closest to the position of the cross-section are depicted. The cross-sectional outer contour of the pelt board 1 at the holding area HA is illustrated with a dash/dotted line 1a which is the contact line of an elastic member encircling the pelt board 1, such as the inner side of a tubular pelt 30 that is stretched onto the pelt board 1.

Thus, the length of the cross-sectional outer contour 1a determined in this manner is the cross-sectional circumference of the pelt board 1 at the position of the cross-section. The cross-sectional circumference is determined when the pelt board is expanded, i.e. when the expansion means are in the expanded position. In FIG. 2a, the longitudinal part of the distension system 10a, 10b are consequently shown in their outermost or expanded position.

The half parts 4, 5 provides the internal cavity 6 for distributing drying air internally in the pelt board 1 between the half parts 4, 5, see also FIGS. 2 and 6a-6b. It is noted that internal parts of the pelt board 1 in the cavity 6, in the form of elements of the distension system of the pelt board 1, connection parts for interconnecting the half parts 4, 5 and/or the like has been omitted in FIG. 2 in order to enhance the understanding and simplicity of the drawing.

One of the half parts 4 may as shown in FIG. 15b have a substantially flat profile 4a of a width W1 corresponding to about one third of the total circumference of the pelt board 1 at the position of the cross-section, which is at the holding area HA. The other half part 5 has a substantially convex profile 5a and preferably provide as a half shell. The width W2 of the convex profile 5a may in embodiments of the invention corresponds to about 50% of the total circumference of the pelt board 1 at the position of the cross-section, which is at the holding area HA. The height h of the vertex of the convex profile 5a is found as the distance between the vertex and the base line of the convex profile as shown in FIG. 2b. The height h may in embodiments of the invention be larger than the height between the flat profiled part 4 and its base line.

In general, it is to be understood that the present invention is not limited to the particular examples described above but may be adapted in a multitude of varieties within the scope of the invention as specified in e.g. the claims.

### LIST

1: Pelt board
2: Foot end of pelt board
3: tip end of pelt board
4, 5: Half parts of pelt board
4a, 4b: outer surfaces of half parts
6: Internal cavity for distributing drying air internally in said pelt board
7: Ventilation openings in half parts
8: Guiding recess at tip end part of pelt board
9: Drying air supply opening at tip end part of pelt board
10: Distension system
10a, 10b: Longitudinal parts of distension system at longitudinal edges of pelt board
10c: Longitudinal member of distension system arranged in the internal cavity of pelt board
11a, 11b: longitudinal edges of pelt board
12: Upper, elevated edge
13: Elevations at outer surface of half parts for supporting tubular pelt/fur
14a, 15a: Hollow at each half part
16, 16a: Wedge-shaped elements at longitudinal member of distension system
17: Recesses in longitudinal parts of distension system for receiving wedge shaped elements
18: Opposing surfaces comprising wedge shaped elements.
19: Lower part of longitudinal member extending from foot end of pelt board
20: Channel in longitudinal member for guiding drying air into internal cavity
21: Guiding recess surface
22: Wall providing guiding recess surface
23: Upper surface extending at each side of guiding recess
24: Further drying air supply opening at foot end
25: Lower end surface of the pelt board
26: End wall of guiding recess
27: lower edge of opening
30: Tubular fur on pelt board
40: Air exchange part
41: air supply unit for generating flow of drying air
42: outlet of air exchange part
43: inlet of air exchange part
50: Holding device
51: Holding arrangement of holding device
52: common air supply
L1: Length of guiding recess
L2: Length of pelt board
L3: Length of first drying air supply opening at tip end part
h: height of vertex of convex profile
HA: Holding area
H1: Height difference between the upper, elevated edge and recessed surface of guiding recess.
P1: First plane
P2: Centre plane
LD: longitudinal direction of pelt board

What is claimed is:

1. A pelt board for drying tubular furs such as mink furs, wherein said pelt board comprises a foot end and a tip end, and wherein said pelt board comprises:
half parts extending between opposite longitudinal edges of said pelt board, and an internal cavity for distributing drying air in said pelt board between said half parts, and
a distension system configured to reduce or increase the circumference of said pelt board dependent on the setting of said distension system,
wherein said half parts comprises a plurality of ventilation openings for providing a flow of drying air between said internal cavity and the outer surface of said half parts, and
wherein the outer surface of at least one of said half parts comprises an outer guiding recess for receiving an air exchange part for exchanging air in said internal cavity when a tubular fur is arranged on said pelt board,
which guiding recess extends substantially from said tip end of the pelt board in a direction towards said foot end, and which guiding recess ends substantially at a drying air supply opening to said internal cavity.

2. A pelt board according to claim 1, wherein said drying air supply opening extends between the recessed surface of said guiding recess and an upper, elevated edge of said half part, which upper elevated edge is elevated compared to said recessed surface.

3. A pelt board according to claim 1, wherein said guiding recess is configured to provide an opening between the recessed surface of said guiding recess and a tubular fur, when said tubular fur is arranged on the pelt board so that the air exchange part can be inserted between said recessed surface and said tubular fur after the tubular pelt is arranged on the pelt board.

4. A pelt board according to claim 1, wherein the length of said guiding recess is no more than ¼ of the length of the pelt board such as no more than 1/10 of the length of the pelt board, e.g. no more than 1/15 of the length of the pelt board.

5. A pelt board according to claim 1, wherein at least one of said half part provides a curved outer profile.

6. A pelt board according to claim 1, wherein said pelt board comprises a first plane extending through said longitudinal edges of said pelt board in the longitudinal direction of said pelt board, and a second centre plane extending in the longitudinal direction of the pelt board and being substantially perpendicular to said first plane, which second centre plane extends through said guiding recess.

7. A pelt board according to claim 1, wherein said guiding recess comprises a support surface for supporting said air exchange part such as a rigid pipe, when said air exchange part is arranged in said guiding recess between a tubular fur arranged on the pelt board, and the support surface of said guiding recess.

8. A pelt board according to claim 1, wherein said distension system is configured to be operated at the foot end of said pelt board in order to either expand or collapse said pelt board.

9. A pelt board according to claim 1, wherein said distension system is configured to be operated at the foot end of said pelt board in order to either expand or collapse said pelt board by displacing a protruding part of a longitudinal member of said distension system in the longitudinal direction of the pelt board, which longitudinal member extends in the longitudinal direction of said pelt board inside said cavity.

10. A pelt board according to claim 1, wherein said drying air supply opening at said tip end part is oblong, such as wedge shaped, rectangular or oval, and extends in the longitudinal direction of said pelt board.

11. A pelt board according to claim 1, wherein said drying air supply opening extends in a substantially transverse direction compared to the longitudinal direction of said pelt board.

12. A pelt board according to claim 1, wherein said internal cavity extends in between a recessed wall part providing said guiding recess and the opposing half part.

13. A pelt board according to claim 1, wherein a recessed wall part providing said guiding recess is displaced from a first plane extending through said longitudinal edges of said pelt board in the longitudinal direction of said pelt board, so that drying air can flow between said first plane and the inner surface of the wall part inside the cavity, and preferably so that a longitudinal member for operating the distension system can extend between said wall part and the other half part substantially in said first plane.

14. A pelt board according to claim 1, wherein said pelt board is moreover configured for receiving drying air through a further drying air supply opening to said interior cavity at the foot end of said pelt board.

15. A drying system for drying tubular pelts/furs, where said drying system comprises one or more pelt boards according to claim 1, and one or more holding devices, each holding device comprising a holding arrangement for holding said pelt board so that the pelt board hangs substantially vertically from said holding device from the tip end of said pelt board, and wherein said holding device comprises said air exchange part such as a rigid pipe or a hose to be provided in said guiding recess from said tip end between said tubular fur and the surface of said guiding recess.

16. A method of drying tubular furs such as mink furs on a pelt board, wherein said pelt board comprises:
a foot end and a tip end,
half parts extending between opposite longitudinal edges of said pelt board,
an internal cavity for distributing drying air in said pelt board between said half parts,
a distension system configured to reduce or increase the circumference of said pelt board dependent on the setting of said distension system,
wherein said half parts comprises a plurality of ventilation openings for providing a flow of drying air between said internal cavity and the outer surface of said half parts,
wherein the outer surface of at least one of said half parts comprises an outer guiding recess for receiving an air exchange part for exchanging air in said internal cavity when a tubular fur is arranged on said pelt board, which guiding recess extends substantially from said tip end of the pelt board in a direction towards said foot end, and which guiding recess ends substantially at a drying air supply opening to said internal cavity,
wherein said method comprises the steps of:
drawing said tubular fur onto said pelt board from said tip end towards said foot end so the skin side of the tubular pelt faces the outer surface of said pelt board,
fixing the pelt to the pelt board by fixation means,
providing an air exchange part into said guiding recess between the surface of said guiding recess and said tubular pelt from the tip end of said pelt board, and
providing a flow of drying air by means of said air exchange part so as to provide an airflow in said internal cavity of said pelt board through said drying air supply opening so that air between said tubular fur and the outer surface of said half parts is exchanged.

17. A method according to claim 16, wherein said method comprises the step of arranging said pelt board at a holding device by means of a holding arrangement so that said pelt board hangs substantially vertically from said holding device from the tip end of said pelt board.

18. A method according to claim 17, wherein said holding arrangement comprises a clamp.

19. A method according to claim 17, wherein said holding device comprises said holding arrangement and said air exchange part.
